(19) United States
(12) Patent Application Publication
(10) Pub. No.: US 2020/0072618 A1
(43) Pub. Date: Mar. 5, 2020

(54) METHOD AND DEVICES FOR MONITORING PHYSICAL QUANTITIES OF A GEOGRAPHICAL ZONE

(71) Applicant: SUEZ GROUPE, Paris La Defense Cedex (FR)

(72) Inventors: Carole BLOQUET, Issey-Les-Moulineaux (FR); François BOYER, Paris (FR)

(21) Appl. No.: 16/463,215

(22) PCT Filed: Nov. 21, 2017
(86) PCT No.: PCT/EP2017/079972

§ 371 Date: May 22, 2019

(30) Foreign Application Priority Data
Nov. 22, 2016 (FR) 1661368

(51) Int. Cl. G01C 21/32; G06F 16/29; G09B 29/10

(52) U.S. Cl. CPC G01C 21/32; B60T 2210/36; G09B 29/102; G06F 16/29

(57) ABSTRACT

A method for generating data of interest relating to a geographical zone, by an item of computing equipment, on the basis of a datum and of a geographical position originating from a transmission (Tr1) by a transmission unit (122), includes making a vehicle (104) travel around a predetermined path (T1) of the geographical zone at a temporal frequency, the transmission unit being embedded on board the vehicle transmitting to the item of computing equipment the datum and a geographical position, the geographical position corresponding to the geographical position of a sensor (106) embedded on board the vehicle, while the vehicle is travelling around the path, at the moment of a generation of a value (108) of a physical quantity in a monitoring zone (112) outside the vehicle, the datum being generated by a processing, by a processing unit (114) embedded on board the vehicle, of the value.

### TECHNICAL FIELD

The invention relates to a method for generating data of interest relating to a geographical area.

The invention also relates to a vehicle, a system and a computer program product for implementing this method.

### PRIOR ART

More and more data related to the environment, availability and status of services according to a situation at a given time are captured, collected, recorded, analyzed and returned to a client.

The data is read by staff or hardware dedicated to the service concerned. This is the case, for example, for remote reading, that is to say the remote reading of meters by the operator of a fluid, for a network or highway inspection by the concession holder, for measuring noise pollution or gas by the body responsible for this measurement. This reading is sometimes carried out with the participation of the users. It is performed through information collection campaigns which are intermittent in time or in space or thanks to the use of fixed sensors covering only a portion of the territory.

One object of the invention is to provide a method for generating data of interest relating to a geographical area that does not produce additional pollution with regard to capturing this data.

One object of the invention is to provide a method for generating data of interest relating to a geographical area that reduces the number of transport devices needed for capturing this data.

One object of the invention is to provide a method for generating data of interest relating to a geographical area, the cost of installation and maintenance of which is less than the method known to the prior art.

### DISCLOSURE OF THE INVENTION

At least one object of the invention is achieved with, according to a first aspect of the invention, a method for generating data of interest relating to a geographical area, by an item of computing equipment, from a first datum and from a first geographical position, originating from a transmission by a first remote transmission unit of said item of computing equipment, characterized in that it comprises causing a first vehicle to travel on a first predetermined path of the geographical area at a first temporal frequency greater than a predetermined temporal frequency, said first transmission unit being embedded in said first vehicle and being arranged for transmitting the first datum and a first geographical position to said first item of computing equipment.

According to the first aspect of the invention, said first geographical position corresponding to the geographical position of a first sensor embedded in said first vehicle, during the travel of said first vehicle on the first path, at the time of generating a first value, determined by said first sensor, of a first physical quantity in a first monitoring area outside said first vehicle, said first datum being generated by a processing, by a first processing unit embedded in said first vehicle, of said first value.

The vehicle may be a truck, a bus, a train, or a tram.

Throughout the description, when a first object is designated, it does not mean that a second object forms part of the invention. By first object, the description may refer to a single object or at least one first object. Throughout the description, when a second object is designated, it does not mean that a third object forms part of the invention. By second object, the description may refer to a single object, the second object, or at least one second object.

For example, the vehicle may be a waste collection truck.

Preferably, the first temporal frequency is greater than a predetermined temporal frequency, termed the analysis frequency. The analysis frequency may be equal to one per week.

The first determined temporal frequency may be equal to one of the working days of a week.

Advantageously, the vehicle may travel on the first predetermined path for a different use from that of capturing a physical quantity. By providing such a method, generating data of interest relating to the geographical area does not cause specific pollution relating to capturing data of interest.

By travel of a vehicle on a path, the present description refers to any instant between an instant of departure and an instant of arrival corresponding, respectively, to a place of departure and place of arrival of said path. Thus, the vehicle is not necessarily moving throughout the travel of said vehicle on the path.

During the travel of the vehicle on a path, the vehicle may be moving or stationary.

Sensors may only be used when the vehicle is stationary. Other sensors may be used only when the vehicle is moving. Still other sensors may be used both while the vehicle is stationary and while the vehicle is moving.

According to a variant of the method according to the first aspect of the invention, or one of its improvements, a determination of a physical quantity by a sensor may be performed while the vehicle is moving.

According to a second variant of the method according to the first aspect of the invention, or one of its improvements, a determination of a physical quantity by a sensor may be performed while the vehicle is stationary.

According to a third variant of the method according to the first aspect of the invention, or one of its improvements, a determination of a physical quantity by a sensor may be performed when the vehicle is stationary and when the vehicle is moving.

By computing equipment, the present description refers to an item of equipment comprising means for receiving the data transmitted by the vehicle and for processing said data. Such an item of equipment may, for example, be a computer server. Preferably, the computing equipment is arranged at a distance from the first transmission unit.

The transmission of the first datum may be wired or wireless.

The transmission unit may be a Wi-Fi or GSM transmitter or a transmitter of another technology.

The geographical position may be determined by a unit for determining geographical position such as a GNSS (“Global Navigation Satellite System”) unit for receiving and processing signals, e.g. GPS (“Global Positioning System”) signals.

The first datum may be raw, i.e. be equal to the first value of the first physical quantity.

The vehicle may comprise one or more sensors, e.g. of different types, notably gas concentration, image, mechanical vibration, sound vibration, pressure, temperature, radio wave, and the processing unit may be configured for notably determining a concentration of odor and/or pollutant, a strain profile, noise, a radio-encoded datum, from the data captured by the various sensors.

The first datum may be transmitted in real time or off-line. When the first datum is transmitted off-line, the first vehicle further comprises a data storage unit, the first processing unit being further configured for storing the first datum of interest in said data storage unit.

The first datum may relate to a noise, an odor, a temperature, a climate datum, a datum relating to air quality, an image, any datum from an image processing, any datum from a wave measuring apparatus (e.g. radar, scanner, infrared, sonar), a vibration datum, a reading from terminals, meters, user messages (preferably outside of the GSM network), and more generally any data from measuring instruments.

The monitoring area outside the vehicle is the area covered by the sensor. This monitoring area makes it possible to gain knowledge of the environment in which the vehicle operates.

Advantageously, the step of transmitting the first datum and/or the first geographical position may be performed in real time during the travel of the first vehicle on the first path. Thus, the method according to the first aspect of the invention makes it possible to generate data of interest without waiting for a return of the vehicle to a base provided with means of retrieving this data.

Preferably, the step of generating the first datum and of generating the first geographical datum may be iterated during the travel of the first vehicle on the first path. Thus, the method according to the first aspect of the invention makes it possible to generate data of interest relating to different places in the geographical area by means of the same sensor.

According to one possibility, the method according to the first aspect of the invention, or one of its improvements, may comprise comparing the first datum to a predetermined threshold.

The method according to the first aspect of the invention, or one of its improvements, may further comprise a processing of the data of interest and a transmission of the processed data of interest to a second item of computing equipment. The processed data of interest may relate to the detection of a gas leak, reading fluid meters of private individuals, a measurement of a measuring apparatus, a thermographic diagnosis of a frame, a measurement of surface temperatures, air quality, or noise level.

The processed data of interest may relate to the safety of people, of property, a citizenship check (parking, posters/tags, vandalism), to monitoring risks (weather phenomena such as snow, ice, wind), to monitoring the state of the highways, railroads and waterways, urban furniture, or signage.

The processed data of interest may relate to a diagnosis of pruning requirements or to video monitoring, or to tracking the itinerary of a vehicle.

In one embodiment, the processing of the data of interest may generate a mapping, said mapping having value levels of the first physical quantity represented in different places of the geographical area. By mapping the present description refers to any spatial representation of a non-geographical reality, notably in the form of a map, plane or spatial.

According to one possibility, the data of interest may further be generated from a second datum and a second geographical position originating from a second transmission by a second transmission unit of the first item of computing equipment, comprising causing a second vehicle to travel on a second predetermined path of the geographical area at a second temporal frequency, said second transmission unit being embedded in said second vehicle and being arranged for transmitting the second datum and the second geographical position to said first item of computing equipment.

According to this last possibility, said second geographical position may correspond to the geographical position of a second sensor embedded in said second vehicle, during the travel of said second vehicle on the second path, at the time of generating a second value, determined by said second sensor, of a second physical quantity in a second monitoring area outside said second vehicle, said second datum being generated by a processing, by a second processing unit embedded in said second vehicle, of said second value.

The first and second predetermined paths may be identical or distinct.

Preferably, the second temporal frequency is greater than the analysis frequency.

The first and second temporal frequencies of travel may be identical or distinct.

Preferably, the computing equipment is arranged at a distance from the second transmission unit.

The physical quantities captured by the first and second sensors may be identical or distinct.

According to a second aspect of the invention, a method is provided for fitting out a vehicle traveling on a first predetermined path of the geographical area at a first temporal frequency, for a use different from the capture of a physical quantity, with devices necessary to, and configured for, implementing the method according to the first aspect of the invention, or one of its improvements. This method may make it possible to reduce the number of devices necessary for capturing the physical quantities.

In the method for fitting out, the first temporal frequency may be different from, or equal to, the analysis frequency.

Advantageously, the first datum of interest, the first geographical position, the second datum of interest and the second geographical position may be recorded in the same database.

According to an advantageous aspect, the method according to the first aspect of the invention may comprise a longitudinal analysis of the first and/or second data of interest by the first item of computing equipment.

According to a third aspect of the invention, a vehicle is provided, comprising:
a first sensor embedded in said vehicle configured for determining a first value of a first physical quantity in a first monitoring area outside the vehicle, during a travel of said vehicle on a first path,
a first processing unit embedded in said vehicle and configured for generating a first datum from said first value,
a first unit for determining geographical position configured for generating a first geographical position corresponding to the geographical position of said first sensor at the time of determining said first value,
a first transmission unit arranged for transmitting said first datum and said first geographical position to a first item of computing equipment, preferably remote from the vehicle.

The first and second monitoring area outside the vehicle may be identical.

The first processing unit may be a computer in the vehicle.

The first unit for determining geographical position may be a unit for determining the geographical position of the vehicle, e.g. a GPS system installed in the passenger compartment of the vehicle.

The first transmission unit may be a transmission unit in the vehicle, e.g. arranged in the passenger compartment of the vehicle.

The first transmission unit may be incorporated into a portable device, e.g. carried by a driver of the vehicle, e.g. a smartphone of said driver.

Preferably, the first sensor and/or the first processing unit and/or the first unit for determining geographical position and/or the first transmission unit are removably attached to the vehicle. By removably attached, the present description refers to “plug and play” type devices. Such systems may be installed and uninstalled with the aid of simple, optionally specific, tools but without the need to visit a workshop or garage for the purpose of, for example, placing the vehicle on a vehicle lift.

Advantageously, the first sensor and/or the first processing unit and/or the first unit for determining geographical position and/or the first transmission unit may be originally installed on the vehicle.

According to one embodiment, the vehicle may comprise a second sensor arranged embedded in said vehicle configured for determining a second value of a second physical quantity in a second monitoring area outside the vehicle, during the travel of said vehicle on the first path.

The first physical quantity and second physical quantity may be different. Measuring various physical quantities may make it possible to establish correlations between the quantities.

Preferably, the vehicle may comprise an electrical power supply unit dimensioned to provide for the electrical power supply of the first sensor, of the first processing unit and of the first transmission unit, during the travel of said vehicle in the geographical area on the first predetermined path.

Advantageously, the electrical power supply unit may be dimensioned to further provide for causing said vehicle to travel from a place of departure to a place of arrival on the first predetermined path. This is, for example, the case of a hybrid vehicle.

According to one possibility, the vehicle may not comprise electrical connection means to an external electrical power supply to the device arranged for powering the vehicle when it moves on the first predetermined path. According to one possibility, the vehicle may be autonomous.

According to a fourth aspect of the invention, a system is provided for generating data of interest relating to a geographical area comprising an item of computing equipment and a vehicle according to the third aspect of the invention, or one of its improvements, wherein the first item of computing equipment, to which are transmitted the first datum and the first geographical position is the item of computing equipment of the system, said item of computing equipment being arranged for processing the first datum and for generating the data of interest.

The data generating system may further comprise a transmission unit configured for transmitting the data of interest to a second item of computing equipment.

By data processing unit, the present description refers to any digital computing means for processing data, e.g. a microprocessor.

According to a fifth aspect of the invention, a computer program product is provided, preferably only implemented by technical means, directly loadable into the internal memory of a computing unit, comprising instructions which, when they are executed by the computing unit, implement the steps of the method according to the first aspect of the invention or one of its improvements.

### DESCRIPTION OF THE FIGURES

Other features and advantages of the invention will become apparent on reading the detailed description of implementation and embodiment in no way restrictive, with respect to the appended FIGURE in which:

FIG. 1 illustrates a first embodiment of a method 100 according to the invention.

### DESCRIPTION OF THE INVENTION

Since this embodiment is in no way restrictive, variants of the invention may notably be produced comprising only a selection of features subsequently described, as described or generalized, isolated from the other features described, if this selection of features is sufficient to impart a technical advantage or to differentiate the invention from the prior art.

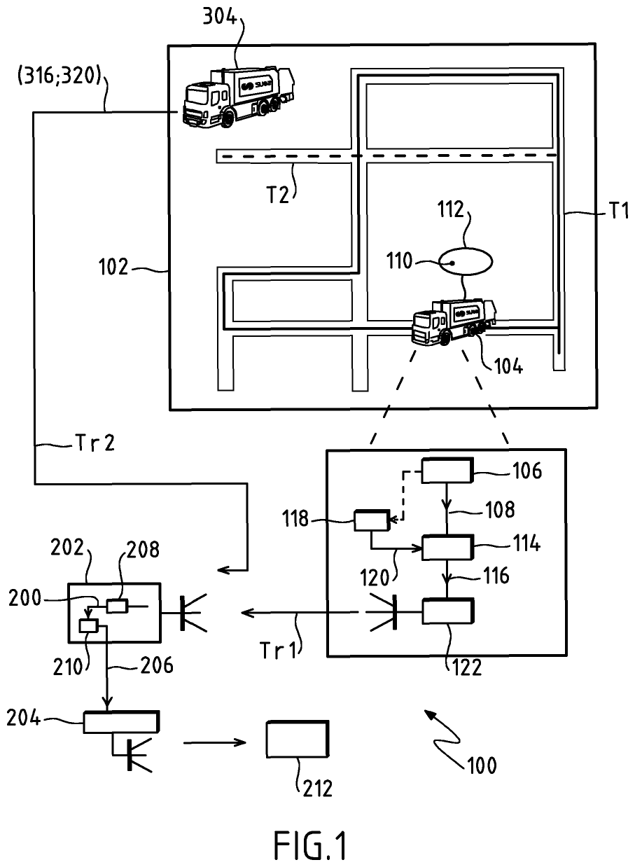

FIG. 1 represents an embodiment of a method 100 for generating data of interest relating to a geographical area 102 according to the invention.

The method 100 comprises causing a first vehicle 104 to travel, on a first predetermined path T1 of the geographical area 102. In the example represented, the first vehicle 104 is a waste collection truck.

According to the embodiment of the method 100, the first vehicle 104 travels at a first temporal frequency f1 greater than a predetermined temporal frequency fp. In the example represented, the temporal frequency f1 is once per working day while the predetermined temporal frequency fp is once per week.

As illustrated in FIG. 1, the first vehicle 104 comprises:
a first sensor 106 embedded in the first vehicle 104 configured for determining a first value 108 of a first physical quantity—here the temperature—in a first monitoring area 112 outside the first vehicle 104,
a first processing unit 114 embedded in the first vehicle 104 and configured for generating a first datum 116 from the first value 108,
a first unit for determining geographical position 118 configured for generating a first geographical position 120 corresponding to the geographical position of said first sensor 106 at the time of determining the first value 108,
a first transmission unit 122 arranged for transmitting said first datum 116 and said first geographical position 120 to a first item of computing equipment 202, remote from the first vehicle 104.

The dotted arrow connecting the first sensor 106 and the first unit for determining geographical position 118 illustrates the temporal synchronization of the determination of the first value 108 and the first geographical position 120.

The method 100 comprises generating data of interest 200, by the first item of computing equipment 202, by means of a data processing unit 208, from the first datum 116 and the first geographical position 120 originating from a transmission Tr1 by the first transmission unit 122.

In the embodiment of the method 100, the step of transmitting the first datum 116 and the first geographical position 120 is performed in real time during the travel of the first vehicle 104 on the first path T1.

In the embodiment of the method 100, the step of generating the first datum 116 and the first geographical position 120 is iterated during the travel of the first vehicle on the first path T1.

Furthermore, in the embodiment of the method 100, the transmission of the first datum 116 and of the first geographical position 120 by the first transmission unit 122 of the first vehicle 104 is iterated during the travel of the first vehicle 104 on the first path T1. Thus real-time information may be received without waiting for the return of the first vehicle 104 to a base provided with means of retrieving this information.

The method 100 further comprises a processing of the data of interest 200, by means of a data processing unit 210, and a transmission of the processed data of interest 206 by means of a transmitter 204, to a second item of computing equipment 212.

The data processing units 208 and 210 may be distinct or only form a single data processing unit.

The method 100 comprises comparing the first datum 116 to a predetermined threshold. This comparison may be performed by the processing unit 208. In the event of the predetermined threshold being exceeded, the comparison may generate an alarm, as a datum of interest 200.

In the embodiment of the method 100, the processing of the data of interest generates a mapping (not illustrated), said mapping having value levels of the first physical quantity represented in different places of the geographical area.

FIG. 1 further illustrates that the data of interest 200 are further generated from a second datum 316 and a second geographical position 320 originating from a second transmission Tr2 by a second remote transmission unit (not represented) of the item of computing equipment 202.

The method 100 comprises causing a second vehicle 304 to travel on a second predetermined path T2 of the geographical area 102 at a second temporal frequency greater than the predetermined temporal frequency f2.

In the example represented, the second vehicle 304 is a waste collection truck. In the example represented, the temporal frequency f2 is one per working day.

The second transmission unit is embedded in the second vehicle 304 and is arranged for transmitting the second datum 316 and the second geographical position 320 to the first item of computing equipment 202.

As previously, the second geographical position corresponds to the geographical position of a second sensor embedded in the second vehicle 304, during the travel of the second vehicle 304 on the second path, at the time of generating a second value, determined by the second sensor, of a second physical quantity—here the temperature—in a second monitoring area outside the second vehicle 304, the second datum being generated by a processing, by a second processing unit embedded in the second vehicle 304, of the second value.

By data processing unit, the present description refers to any digital computing means for processing data, e.g. a microprocessor.

Of course, the invention is not limited to the examples which have just been described and numerous adjustments may be made to these examples without departing from the scope of the invention. In addition, the various features, forms, variants and embodiments of the invention may be combined with each other in various combinations insofar as they are not incompatible or mutually exclusive of each other.

1. A method (100) for generating data of interest (200) relating to a geographical area (102), by an item of computing equipment (202), from a first datum (116) and from a first geographical position (120) originating from a transmission (Tr1) by a first transmission unit (122), the method comprising causing a first vehicle (104) to travel on a first predetermined path (T1) of the geographical area at a first temporal frequency, said first transmission unit being embedded in said first vehicle and being arranged for transmitting the first datum and a first geographical position to said first item of computing equipment, said first geographical position corresponding to the geographical position of a first sensor (106) embedded in said first vehicle, during the travel of said first vehicle on the first path, at the time of generating a first value (108), determined by said first sensor, of a first physical quantity in a first monitoring area (112) outside said first vehicle, said first datum being generated by a processing, by a first processing unit (114) embedded in said first vehicle, of said first value.

2. The method as claimed in claim 1, wherein the step of transmitting the first datum and/or the first geographical position is performed in real time during the travel of the first vehicle on the first path.

3. The method as claimed in claim 1, wherein the step of generating the first datum and of generating the first geographical datum is iterated during the travel of the first vehicle on the first path.

4. The method as claimed in claim 1, further comprising comparing the first datum with a predetermined threshold.

5. The method as claimed in claim 1, further comprising a processing of the data of interest and a transmission of the processed data of interest (206) to a second item of computing equipment (212).

6. The method as claimed in claim 5, wherein the processing of the data of interest generates a mapping, said mapping having value levels of the first physical quantity represented in different places of the geographical area.

7. The method as claimed in claim 1, wherein the data of interest are further generated from a second datum (316) and a second geographical position (320) originating from a second transmission (Tr2) by a second transmission unit of the first item of computing equipment, comprising causing a second vehicle (304) to travel on a second predetermined path (T2) of the geographical area at a second temporal frequency, said second transmission unit being embedded in said second vehicle and being arranged for transmitting the second datum and the second geographical position to said first item of computing equipment,
said second geographical position corresponding to the geographical position of a second sensor embedded in said second vehicle, during the travel of said second vehicle on the second path, at the time of generating a second value, determined by said second sensor, of a second physical quantity in a second monitoring area outside said second vehicle, said second datum being generated by a processing, by a second processing unit embedded in said second vehicle, of said second value.

8. The method as claimed in claim 7, wherein the first datum of interest, the first geographical position, the second datum of interest and the second geographical position are recorded in the same database.

9. The method according to claim 7 or 8, further comprising a longitudinal analysis of the first and second data of interest by the first item of computing equipment.

10. A vehicle (104), comprising:
a first sensor (106) embedded in said vehicle configured for determining a first value (108) of a first physical quantity in a first monitoring area (112) outside the vehicle, during a travel of said vehicle on a first path,
a first processing unit (114) embedded in said vehicle and configured for generating a first datum (116) from said first value,
a first unit for determining geographical position (118) configured for generating a first geographical position (120) corresponding to the geographical position of said first sensor at the time of determining said first value, and
a first transmission unit (122) arranged for transmitting said first datum and said first geographical position to a first item of computing equipment (200).

11. The method as claimed in claim 10, wherein the first sensor and/or the first processing unit and/or the first unit for determining geographical position and/or the first transmission unit are removably attached to the vehicle.

12. The vehicle as claimed in claim 10, wherein the first sensor and/or the first processing unit and/or the first unit for determining geographical position and/or the first transmission unit are originally installed on the vehicle.

13. The vehicle as claimed in claim 10, further comprising a second sensor arranged embedded in said vehicle configured for determining a second value of a second physical quantity in a second monitoring area outside the vehicle, during the travel of said vehicle on the first path.

14. The method as claimed in claim 13, wherein the first physical quantity and second physical quantity are different.

15. The vehicle as claimed in claim 10, comprising an electrical power supply unit dimensioned to provide for the electrical power supply of the first sensor, of the first processing unit and of the first transmission unit, during the travel of said vehicle in the geographical area on the first predetermined path.

16. The method as claimed in claim 15, wherein the electrical power supply unit is dimensioned to further provide for causing said vehicle to travel from a place of departure to a place of arrival on the first predetermined path.

17. The vehicle as claimed in claim 10, not comprising electrical connection means to an external electrical power supply to the device arranged for powering the vehicle when it moves on the first predetermined path.

18. A system for generating data of interest relating to a geographical area comprising an item of computing equipment and a vehicle according to claim 10, wherein the first item of computing equipment, to which are transmitted the first datum and the first geographical position is the item of computing equipment of the system, said item of computing equipment being arranged for processing the first datum and for generating the data of interest.

19. The system as claimed in claim 18, further comprising a transmission unit configured for transmitting the data of interest to a second item of computing equipment.

20. A non-transitory computer program product, directly loadable into the internal memory of a computing unit, comprising instructions which, when they are executed by the computing unit, implement the steps of the method as claimed in claim 1.
